(19) United States
(12) Patent Application Publication
(10) Pub. No.: US 2005/0281531 A1
(43) Pub. Date: Dec. 22, 2005

(54) Television viewing apparatus

(76) Inventor: Musa Raoul Unmehopa, Amersfoort (NL)

Correspondence Address: Lucent Technologies Inc.;Docket Administrator, Room 3J-219, 101 Crawfords Corner Road, Holmdel, NJ, 07733-3030, US

(21) Appl. No.: 10/869,405

(22) Filed: Jun. 16, 2004

(51) Int. Cl. H04N 5/76

(52) U.S. Cl. 386/46; 386/68

(57) ABSTRACT

The problem of viewers of television programs falling asleep while watching is alleviated by apparatus for viewing television broadcasts comprising a television receiver 1, a television display 3, a digital video recorder 4 connected between the receiver and the display, the digital video recorder having a live-pause facility, and a sleep detector 8 for monitoring the wakefulness of a viewer of a television broadcast and arranged to cause the digital video recorder to pause the playing of the broadcast upon detecting that the viewer has fallen asleep. Upon waking, the viewer may resume the playing of the broadcast when convenient. Alternatively, the sleep detector may be arranged to resume the playing upon detecting that the viewer has woken up.

### TECHNICAL FIELD

The present invention relates to communication systems, and more particularly to apparatus for viewing television broadcasts.

### BACKGROUND OF THE INVENTION

Apparatus for recording television programs for later viewing are now well-known and extremely widely available consumer items. Mostly, such apparatus records programs in analog form on tape but, more recently, apparatus has become available that records programs in digital form, either on digital video disc (DVD) for permanent storage or, for temporary storage, on computer-type memory, such as disk memory.

Since computer-type memory has very fast access times, it is possible, and is also well-known, to configure such recording apparatus, known as a Digital Video Recorder (DVR), to provide a “live-pause” facility. If a viewer is watching a program and wishes or needs to stop watching temporarily, for example to make a cup of tea or answer the telephone, he or she presses a PAUSE button on the TV remote control and the display freezes. Upon return, the viewer presses a PLAY button on the remote control and the program continues from the point at which it left off.

What really happens is that the DVR records the program while the viewer is watching it. When the PAUSE button is pressed, placing the DVR into PAUSE mode, the DVR continues to record the program, but stops the display, for example by repeatedly sending the last frame of the program to the display device and muting the sound, producing a “freeze frame” effect. The DVR also stores the address of the memory location corresponding to the point in the program that was being displayed when the PAUSE button was pressed. When the PLAY button is pressed, placing the DVR into PLAY mode, the DVR starts to play back the recorded program from the point at which it paused, while at the same time continuing to record the program. Thus, the viewer, who started watching the broadcast as it was actually being transmitted, is now watching a time-shifted version of the broadcast.

A problem with television watching, which is not addressed by the live-pause facility, arises out of the fact that it is a sedentary and somewhat passive activity, frequently undertaken at a time of day when the viewer is tired from the business of the day. It is also not unknown for moderate quantities of alcohol to be consumed prior to and even during the watching of television programs. A combination of any or all of these factors, together with others, such as programs which are less than completely absorbing, can lead to the viewer falling asleep while watching and, as a result, missing something which might be interesting, amusing, or even important.

Consequently, there is a need for alleviating the problem of a viewer falling asleep whilst watching television.

### SUMMARY OF THE INVENTION

In one embodiment of the present invention, an apparatus is provided for use with television equipment. The apparatus may includes a digital video recorder having PAUSE and PLAY controls and a sleep detector for monitoring the wakefulness of a viewer of the television equipment and arranged to activate the PAUSE control of the digital video recorder upon detecting that the viewer has fallen asleep.

If the viewer wakes up, he or she can then, when convenient, operate the PLAY control to resume viewing. Alternatively the sleep detector may be arranged to activate the PLAY control upon detecting that the viewer has woken up.

In another embodiment of the present invention, an apparatus is provided for viewing television broadcasts. The apparatus includes a television receiver, a television display, a digital video recorder connected between the receiver and the display, the digital video recorder having a live-pause facility, and a sleep detector for monitoring the wakefulness of a viewer of a television broadcast and arranged to cause the digital video recorder to pause the playing of the broadcast upon detecting that the viewer has fallen asleep.

The viewer may then, after waking up, resume the playing of the broadcast when it is convenient. Alternatively the sleep detector may be arranged to resume the playing of the broadcast upon detecting that the viewer has woken up.

The sleep detector may comprise an electronic camera for forming images of the viewer, and pattern recognition means connected to the electronic camera to monitor the physical condition of the viewer. For example, the pattern recognition means determine whether the viewer's eyes are open or shut. The apparatus may further include logic means connected to receive output from the pattern recognition means to distinguish normal blinking from the onset of sleep.

Alternatively, the sleep detector may comprise a device wearable by the viewer for monitoring the physical condition of the viewer. For example, the wearable device may include one or more of an accelerometer, a heat flux sensor, a galvanic skin response sensor, a skin temperature sensor and a near-body ambient temperature sensor.

The sleep detector may be connected to the digital video recorder via direct electrical connection or via a remote-control type interface.

### BRIEF DESCRIPTION OF THE DRAWING

The present invention will be better understood from reading the following description of non-limiting embodiments, with reference to the attached drawings, wherein below:

FIG. 1 shows known television viewing apparatus incorporating a live-pause facility;

FIG. 2 shows exemplary apparatus embodying the present invention;

FIG. 3 shows an exemplary sleep detector for use in the present invention;

FIG. 4 shows a viewer in a non-sleepy state; and

FIG. 5 shows a viewer in a sleepy state.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

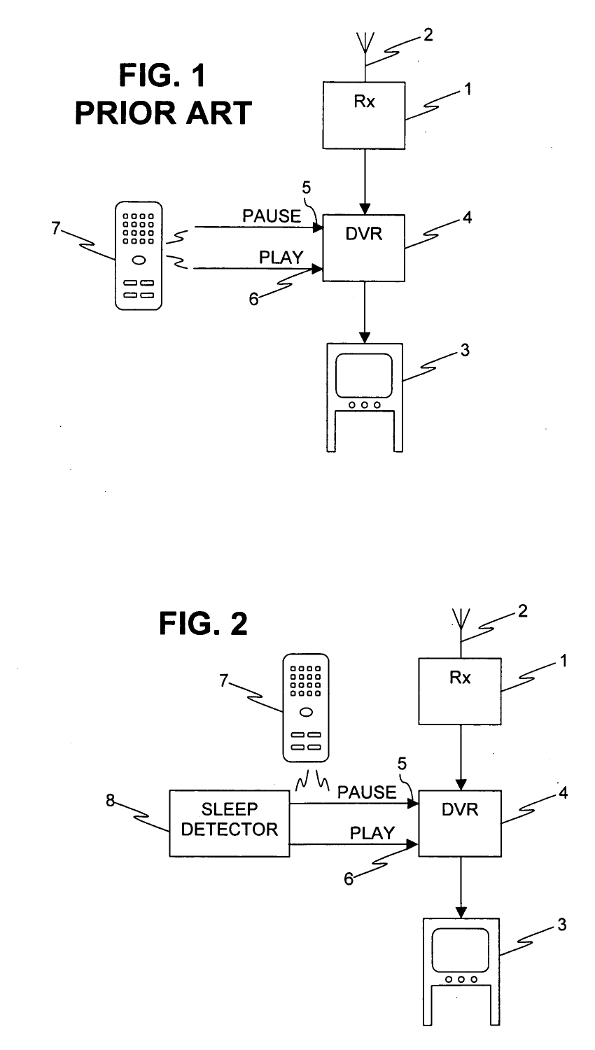

In the known apparatus of FIG. 1 a television receiver apparatus 1 is arranged to receive a television broadcast signal from an antenna 2 and to derive audio and video signals for display on a television display 3. Although, for the sake of example, wireless receiver apparatus is described, the invention may be applied to forms of program distribution other than wireless, for example it may be applied to cable distribution.

A DVR 4 is connected between the receiver 1 and the display apparatus 3 and records the program whilst at the same time passing it on to the display apparatus 3. The DVR has a PAUSE control input 5 and a PLAY control input 6 which can be activated by a remote control unit 7.

When a user is watching a program received by the receiver 1 and displayed by the display 3 and wishes to pause the display, he or she activates the PAUSE control 5 of the DVR 4 by means of the remote control unit 7, whereupon the DVR enters PAUSE mode and continually sends the same video frame to the display 3 while muting the sound, thus freezing the display. Meanwhile the DVR 4 continues to record the program. When the user wishes to resume viewing the program, he or she activates the PLAY control 6 and the DVR 4 enters the PLAY mode, once more sending frames to the display 3 starting from the point at which it stopped, and all the while continuing to record the program.

DVRs suitable for such use are readily available and are supplied, for example, by TiVo, Inc.

In the apparatus shown in FIG. 2, in addition to the remote control unit 7, a sleep detector 8 is provided to operate the PAUSE control 5 and, optionally, the PLAY control 6 of the DVR 4. Thus, the viewer can pause and resume play actively, by means of the remote control unit 7, as with the system of FIG. 1, but can also do so passively, by means of the sleep detector 8.

Sleep detectors as such are well known in the field of vehicle safety and in various medical applications.

In the medical field, sleep detectors are used in investigating sleep disorders, such as insomnia, for the purpose of screening, diagnosis and treatment. A typical convenient device for such use comprises a wearable wrist- or armband with one or more sensors, typically including an accelerometer for detecting movement. Devices are known to have a 2-axis accelerometer, heat flux sensor, galvanic skin response sensor, skin temperature sensor and a near-body ambient temperature sensor. Other techniques include behavioral response monitoring, in which a threshold intensity visual or auditory stimulus is regularly presented to the subject who responds, if awake, by, for example, activating a microswitch, and polysomnography, which is considered to be very reliable, but, at least in the present state of the art, involves bulky and expensive equipment, and will therefore not be further discussed here.

In the vehicle safety field, sleep detectors generally operate on the basis of monitoring a driver's head movements and/or eye movements, such as blinking frequency and length of eye closure. Such detectors typically comprise a CCD camera to be directed at the subject (driver) and image pattern recognition apparatus arranged to locate the eyes of the subject and to determine whether they are open or shut.

The connections between the sleep detector 8 and the PAUSE and PLAY controls 5, 6 of the DVR 4 may be direct electrical connections or may take the form of an infra-red remote-control type of interface. In the case where the sleep detector 8 is worn by or located near to the viewer a remote-control type of interface may be more convenient, whereas in the case where the sleep detector 8 is located near to the DVR 4 direct electrical connections may be more convenient.

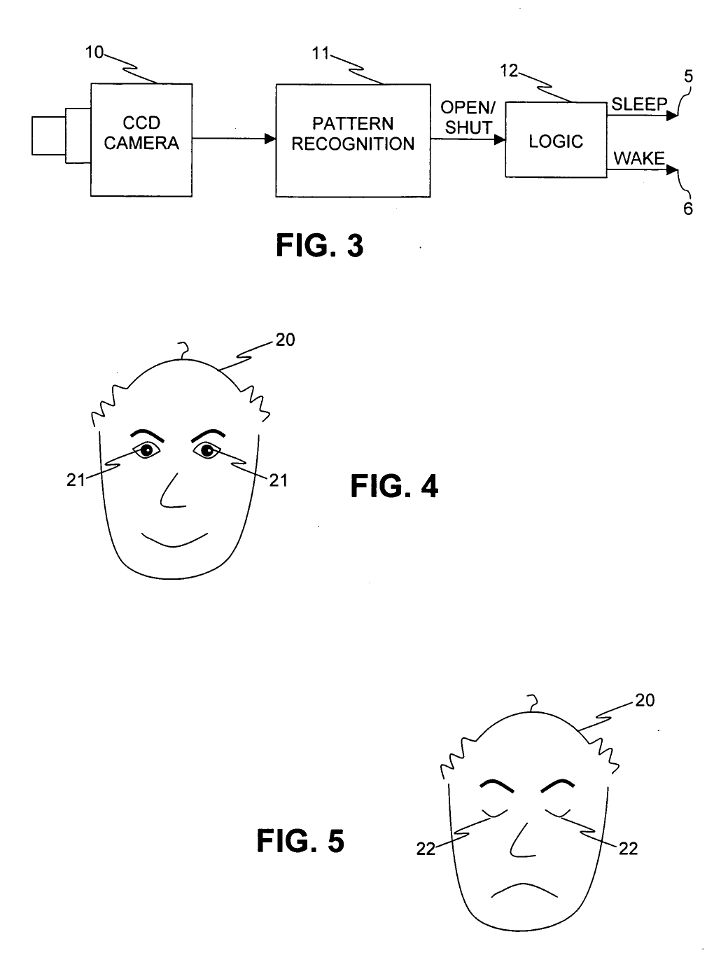

FIG. 3 shows a sleep detector suitable for use as the sleep detector 8 of FIG. 2 and FIGS. 4 and 5 show the face of a viewer 20 in a non-sleepy and a sleepy state respectively. An electronic (e.g. CCD) camera 10, which may be mounted on the television display 3, is directed towards the position of the viewer 20. The electrical image caught by the camera 10 is supplied to a pattern recognition processor 11 which is arranged to analyze the image to locate the eye regions of the viewer and distinguish between open eyes 21 of FIG. 4 and closed eyes 22 of FIG. 5. The pattern recognition processor 11 supplies an OPEN/SHUT signal, indicating the open or shut status of the viewer's eyes, to a logic circuit 12 which filters out short periods of shut eyes due to blinking, and provides a SLEEP signal indicating when the viewer has fallen asleep and a WAKE signal indicating that the viewer has woken up, to activate the PAUSE and PLAY controls respectively of the DVR 4 of FIG. 2.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An apparatus for use by a viewer of television equipment, said apparatus comprising:
a digital video recorder having PAUSE and PLAY controls; and
a sleep detector for monitoring the wakefulness of the viewer of the television equipment and for activating the PAUSE control of the digital video recorder upon detecting that the viewer has fallen asleep.

2. The apparatus of claim 1 wherein said sleep detector is arranged to activate the PLAY control upon detecting that the viewer has subsequently woken up.

3. The apparatus of claim 1 wherein said sleep detector comprises an electronic camera for forming images of the viewer, and pattern recognition means coupled to the electronic camera for monitoring the physical condition of the viewer.

4. The apparatus of claim 3 wherein said pattern recognition means determines if the viewer's eyes are open or shut.

5. The apparatus of claim 4 further comprising logic means for receiving output from said pattern recognition means to distinguish normal blinking from the onset of sleep.

6. The apparatus of claim 1 wherein said sleep detector comprises a device wearable by the viewer for monitoring the physical condition of the viewer.

7. The apparatus of claim 6 wherein said wearable device comprises at least one of accelerometer, a heat flux sensor, a galvanic skin response sensor, a skin temperature sensor and a near-body ambient temperature sensor.

8. The apparatus of claim 1 wherein said sleep detector is coupled to said digital video recorder to activate said PAUSE control via direct electrical connection.

9. The apparatus of claim 1 wherein said sleep detector comprises means for activating said PAUSE control via a remote-control type interface.

10. An apparatus for viewing television broadcasts by a user, the apparatus comprising:
a television receiver;
a television display;
a digital video recorder coupled with said receiver and said display, said digital video recorder having a live-pause facility; and
a sleep detector for monitoring the wakefulness of a viewer of a television broadcast and for causing the digital video recorder to pause the playing of said broadcast upon detecting that the viewer has fallen asleep.

11. The apparatus of claim 10 wherein said sleep detector is arranged to resume the playing of said broadcast upon detecting that the viewer has woken up.

12. The apparatus of claim 10 wherein said television receiver is a wireless television receiver.

13. The apparatus of claim 10 wherein said television receiver is a receiver for cable television broadcasts.
